(19) United States
(12) Patent Application Publication
(10) Pub. No.: US 2018/0186544 A1
(43) Pub. Date: Jul. 5, 2018

(54) Process for Packaging Article with Three-Dimensional Loop Material

(71) Applicant: Dow Global Technologies LLC, Midland, MI (US)

(72) Inventors: Viraj K. Shah, Pearland, TX (US); Bruno Rufato Pereira, Sao Paulo (BR); Marcus Vinicius Pereira De Carvalho, Sao Paulo (BR); Kurt A. Koppi, Midland, MI (US)

(21) Appl. No.: 15/393,652

(22) Filed: Dec. 29, 2016

(51) Int. Cl. B65D 81/02; B65B 23/02; B65B 7/16; B65D 81/107; B65D 5/50; G01N 3/303; G01M 7/02

(52) U.S. Cl. CPC B65D 81/022; B65B 23/02; B65B 7/16; G01M 7/02; B65D 5/509; G01N 3/303; B65D 81/1075

(57) ABSTRACT

The present disclosure provides a process. In an embodiment, a process for producing a packaging article includes providing a body having a geometric shape and composed of a three-dimensional random loop material (3DRLM). The 3DRLM is composed of an olefin-based polymer. The body has a sleeve with opposing ends on respective opposing surfaces of the body. The sleeve extends through an interior portion of the body and has an opening at each respective end. Each opening has a closed width. The process includes providing a product having an insert shape. The insert shape has an insert width that is greater than or equal to the closed width of the sleeve opening. The process includes inserting the product into the sleeve.

### FIELD

The present disclosure relates to protective packaging, and more particularly, to an economical reusable protective packaging article for packing and shipping delicate product susceptible to damage by impact and/or vibration.

### BACKGROUND

Packaging is a fundamental item in supply chain management. Packaging serves to protect valuable product during shipping and storage. Packaging requires sturdy construction and a cushioning feature in order to fulfill its primary function of product protection from physical shock during shipping and storage. As a result, packaging must withstand many stresses such as falls, drops, tips, puncture, vibration and environmental stresses such as extreme temperatures and water. Known are common packaging materials such as corrugated cardboard, packing peanuts, bubble-out bags, air pillow, bubble wrap, and foam sheets.

Overly expensive packaging can reduce an entity's return on investment. Excess packaging material has an undue environmental impact and creates a disposal problem for the customer. Excess packaging material also impacts logistics by increasing the amount of pallet space that each package consumes and the dimensional weight of each package. On the other hand, poor or improper packaging can expose product to undue risk of damage.

Packaging success is the safe arrival of the packaged product to a customer. Safe arrival depends upon adequate exterior strength to allow stacking of packages during shipping and adequate interior strength to keep the packaged product from harm in the event of excessive accelerations, such as dropping of the package. Damaged product as a result of defective packaging, impedes the supply chain, is costly, and is deleterious to customer relations.

Consequently, the art recognizes the need for versatile packaging materials that are sturdy, lightweight, and shock absorbing to meet the demand needs of supply chain management. Also needed is packaging material that is economical, convenient to use and handle, and packaging that is re-usable and/or recyclable.

### SUMMARY

The present disclosure provides a process. In an embodiment, a process for producing a packaging article includes providing a body having a geometric shape and composed of a three-dimensional random loop material (3DRLM). The 3DRLM is composed of an olefin-based polymer. The body has a sleeve with opposing ends on respective opposing surfaces of the body. The sleeve extends through an interior portion of the body and has an opening at each respective end. Each opening has a closed width. The process includes providing a product having an insert shape. The insert shape has an insert width that is greater than or equal to the closed width of the sleeve opening. The process includes inserting the product into the sleeve.

The present disclosure provides another process. In an embodiment, a process for producing a packaging article includes providing a container having (i) a top wall and a bottom wall, (ii) a plurality of sidewalls extending between the top wall and bottom wall. The walls define a compartment. The process includes providing at least two bodies, each body having a geometric shape of an endcap. Each endcap is composed of a three-dimensional random loop material (3DRLM) composed of an olefin-based polymer. Each endcap has a pocket in an interior portion of the body. Each pocket has an opening. Each opening has a closed width. The process includes providing a product having opposing ends. Each product end has an insert shape. The insert shape has an insert width that is greater than or equal to the closed width of the opening. The process includes inserting each product end into a pocket of a respective endcap and forming an endcap-product-endcap assembly. The process includes moving, with the inserting, a portion of the 3DRLM of at least one endcap from a neutral state to a stretched state. The process includes placing the endcap-product-endcap assembly into the container.

### DEFINITIONS AND TEST METHODS

All references to the Periodic Table of the Elements herein shall refer to the Periodic Table of the Elements, published and copyrighted by CRC Press, Inc., 2003. Also, any references to a Group or Groups shall be to the Groups or Groups reflected in this Periodic Table of the Elements using the IUPAC system for numbering groups. Unless stated to the contrary, implicit from the context, or customary in the art, all components and percents are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., 1, or 2, or 3 to 5, or 6, or 7) any subrange between any two explicit values is included (e.g., 1 to 2; 2 to 6; 5 to 7; 3 to 7; 5 to 6; etc.).

Unless stated to the contrary, implicit from the context, or customary in the art, all components and percents are based on weight, and all test methods are current as of the filing date of this disclosure.

Apparent density. A sample material is cut into a square piece of 38 cm×38 cm (15 in×15 in) in size. The volume of this piece is calculated from the thickness measured at four points. The division of the weight by the volume gives the apparent density (an average of four measurements is taken) with values reported in grams per cubic centimeter, g/cc.

Bending Stiffness. The bending stiffness is measured in accordance with DIN 53121 standard, with compression molded plaques of 550 μm thickness, using a Frank-PTI Bending Tester. The samples are prepared by compression molding of resin granules per ISO 293 standard. Conditions for compression molding are chosen per ISO 1872-2007 standard. The average cooling rate of the melt is 15° C./min. Bending stiffness is measured in 2-point bending configuration at room temperature with a span of 20 mm, a sample width of 15 mm, and a bending angle of 40°. Bending is applied at 6°/second (s) and the force readings are obtained from 6 to 600 s, after the bending is complete. Each material is evaluated four times with results reported in Newton millimeters (“Nmm”).

“Blend,” “polymer blend” and like terms is a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate can comprise a blend.

¹³C Nuclear Magnetic Resonance (NMR)

Sample Preparation

The samples are prepared by adding approximately 2.7 g of a 50/50 mixture of tetrachloroethane-d2/orthodichlorobenzene that is 0.025M in chromium acetylacetonate (relaxation agent) to 0.21 g sample in a 10 mm NMR tube. The samples are dissolved and homogenized by heating the tube and its contents to 150° C.

Data Acquisition Parameters

The data is collected using a Bruker 400 MHz spectrometer equipped with a Bruker Dual DUL high-temperature CryoProbe. The data is acquired using 320 transients per data file, a 7.3 sec pulse repetition delay (6 sec delay+1.3 sec acq. time), 90 degree flip angles, and inverse gated decoupling with a sample temperature of 125° C. All measurements are made on non-spinning samples in locked mode. Samples are homogenized immediately prior to insertion into the heated (130° C.) NMR Sample changer, and are allowed to thermally equilibrate in the probe for 15 minutes prior to data acquisition.

“Composition” and like terms is a mixture of two or more materials. Included in compositions are pre-reaction, reaction and post-reaction mixtures the latter of which will include reaction products and by-products as well as unreacted components of the reaction mixture and decomposition products, if any, formed from the one or more components of the pre-reaction or reaction mixture.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Crystallization Elution Fractionation (CEF) Method

Comonomer distribution analysis is performed with Crystallization Elution Fractionation (CEF) (PolymerChar in Spain) (B Monrabal et al, Macromol. Symp. 257, 71-79 (2007)). Ortho-dichlorobenzene (ODCB) with 600 ppm antioxidant butylated hydroxytoluene (BHT) is used as solvent. Sample preparation is done with autosampler at 160° C. for 2 hours under shaking at 4 mg/ml (unless otherwise specified). The injection volume is 300 μm. The temperature profile of CEF is: crystallization at 3° C./min from 110° C. to 30° C., the thermal equilibrium at 30° C. for 5 minutes, elution at 3° C./min from 30° C. to 140° C. The flow rate during crystallization is at 0.052 ml/min. The flow rate during elution is at 0.50 ml/min. The data is collected at one data point/second. CEF column is packed by the Dow Chemical Company with glass beads at 125 μm+6% (MO-SCI Specialty Products) with ⅛ inch stainless tubing. Glass beads are acid washed by MO-SCI Specialty with the request from The Dow Chemical Company. Column volume is 2.06 ml. Column temperature calibration is performed by using a mixture of NIST Standard Reference Material Linear polyethylene 1475a (1.0 mg/ml) and Eicosane (2 mg/ml) in ODCB. Temperature is calibrated by adjusting elution heating rate so that NIST linear polyethylene 1475a has a peak temperature at 101.0° C., and Eicosane has a peak temperature of 30.0° C. The CEF column resolution is calculated with a mixture of NIST linear polyethylene 1475a (1.0 mg/ml) and hexacontane (Fluka, purum, >97.0, 1 mg/ml). A baseline separation of hexacontane and NIST polyethylene 1475a is achieved. The area of hexacontane (from 35.0 to 67.0° C.) to the area of NIST 1475a from 67.0 to 110.0° C. is 50 to 50, the amount of soluble fraction below 35.0° C. is <1.8 wt %. The CEF column resolution is defined in the following equation:

$$Resolution = \frac{\begin{matrix}Peak temperature of NIST 1475 a - \\ Peak Temperature of Hexacontane\end{matrix}}{\begin{matrix}Half \text{-} height Width of NIST 1475 a + \\ Half \text{-} height Width of Hexacontane\end{matrix}}$$

where the column resolution is 6.0.

Density is measured in accordance with ASTM D 792 with values reported in grams per cubic centimeter, g/cc.

Differential Scanning Calorimetry (DSC). DSC is used to measure the melting and crystallization behavior of a polymer over a wide range of temperatures. For example, the TA Instruments Q1000 DSC, equipped with an RCS (refrigerated cooling system) and an autosampler is used to perform this analysis. During testing, a nitrogen purge gas flow of 50 ml/min is used. Each sample is melt pressed into a thin film at about 175° C.; the melted sample is then air-cooled to room temperature (approx. 25° C.). The film sample is formed by pressing a “0.1 to 0.2 gram” sample at 175° C. at 1,500 psi, and 30 seconds, to form a “0.1 to 0.2 mil thick” film. A 3-10 mg, 6 mm diameter specimen is extracted from the cooled polymer, weighed, placed in a light aluminum pan (ca 50 mg), and crimped shut. Analysis is then performed to determine its thermal properties. The thermal behavior of the sample is determined by ramping the sample temperature up and down to create a heat flow versus temperature profile. First, the sample is rapidly heated to 180° C., and held isothermal for five minutes, in order to remove its thermal history. Next, the sample is cooled to −40° C., at a 10° C./minute cooling rate, and held isothermal at −40° C. for five minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tm), peak crystallization temperature (Tc), onset crystallization temperature (Tc onset), heat of fusion (Hf) (in Joules per gram), the calculated % crystallinity for polyethylene samples using: % Crystallinity for PE=((Hf)/(292 J/g))×100, and the calculated % crystallinity for polypropylene samples using: % Crystallinity for PP=((Hf)/165 J/g))×100. The heat of fusion (Hf) and the peak melting temperature are reported from the second heat curve. Peak crystallization temperature and onset crystallization temperature are determined from the cooling curve

Elastic Recovery. Resin pellets are compression molded following ASTM D4703, Annex A1, Method C to a thickness of approximately 5-10 mil. Microtensile test specimens of geometry as detailed in ASTM D1708 are punched out from the molded sheet. The test specimens are conditioned for 40 hours prior to testing in accordance with Procedure A of Practice D618.

The samples are tested in a screw-driven tensile tester using flat, rubber faced grips. The grip separation is set at 22 mm, equal to the gauge length of the microtensile specimens. The sample is extended to a strain of 100% at a rate of 100%/min and held for 30 s. The crosshead is then returned to the original grip separation at the same rate and held for 60 s. The sample is then strained to 100% at the same 100%/min strain rate.

Elastic recovery may be calculated as follows:

$$Elastic Recovery = \frac{( Initial Applied Strain - Permanent Set )}{Initial Applied Strain} \times 100 \%$$

An “ethylene-based polymer” is a polymer that contains more than 50 weight percent polymerized ethylene monomer (based on the total weight of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations.

“High density polyethylene” (or “HDPE”) is an ethylene homopolymer or an ethylene/α-olefin copolymer with at least one C₄-C₁₀ α-olefin comonomer, or C₄ α-olefin comonomer and a density from greater than 0.94 g/cc, or 0.945 g/cc, or 0.95 g/cc, or 0.955 g/cc to 0.96 g/cc, or 0.97 g/cc, or 0.98 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

An “interpolymer” is a polymer prepared by the polymerization of at least two different monomers. This generic term includes copolymers, usually employed to refer to polymers prepared from two different monomers, and polymers prepared from more than two different monomers, e.g., terpolymers, tetrapolymers, etc.

“Low density polyethylene” (or “LDPE”) consists of ethylene homopolymer, or ethylene/α-olefin copolymer comprising at least one C₃-C₁₀ α-olefin, preferably C₃-C₄ that has a density from 0.915 g/cc to 0.940 g/cc and contains long chain branching with broad MWD. LDPE is typically produced by way of high pressure free radical polymerization (tubular reactor or autoclave with free radical initiator). Nonlimiting examples of LDPE include MarFlex™ (Chevron Phillips), LUPOLEN™ (LyondellBasell), as well as LDPE products from Borealis, Ineos, ExxonMobil, and others.

“Linear low density polyethylene” (or “LLDPE”) is a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer. LLDPE is characterized by little, if any, long chain branching, in contrast to conventional LDPE. LLDPE has a density from 0.910 g/cc, or 0.915 g/cc, or 0.920 g/cc, or 0.925 g/cc to 0.930 g/cc, or 0.935 g/cc, or 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

“Ultra low density polyethylene” (or “ULDPE”) and “very low density polyethylene” (or “VLDPE”) each is a linear ethylene/α-olefin copolymer containing heterogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. ULDPE and VLDPE each has a density from 0.885 g/cc, or 0.90 g/cc to 0.915 g/cc. Nonlimiting examples of ULDPE and VLDPE include ATTANE™ ultra low density polyethylene resins (available form The Dow Chemical Company) and FLEXOMER™ very low density polyethylene resins (available from The Dow Chemical Company).

“Multi-component ethylene-based copolymer” (or “EPE”) comprises units derived from ethylene and units derived from at least one C₃-C₁₀ α-olefin comonomer, or at least one C₄-C₈ α-olefin comonomer, or at least one C₆-C₈ α-olefin comonomer, such as described in patent references U.S. Pat. No. 6,111,023; U.S. Pat. No. 5,677,383; and U.S. Pat. No. 6,984,695. EPE resins have a density from 0.905 g/cc, or 0.908 g/cc, or 0.912 g/cc, or 0.920 g/cc to 0.926 g/cc, or 0.929 g/cc, or 0.940 g/cc, or 0.962 g/cc. Nonlimiting examples of EPE resins include ELITE′ enhanced polyethylene (available from The Dow Chemical Company), ELITE AT™ advanced technology resins (available from The Dow Chemical Company), SURPASS™ Polyethylene (PE) Resins (available from Nova Chemicals), and SMARTT™ (available from SK Chemicals Co.).

“Single-site catalyzed linear low density polyethylenes” (or “m-LLDPE”) are linear ethylene/α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. m-LLDPE has density from 0.913 g/cc, or 0.918 g/cc, or 0.920 g/cc to 0.925 g/cc, or 0.940 g/cc. Nonlimiting examples of m-LLDPE include EXCEED™ metallocene PE (available from ExxonMobil Chemical), LUFLEXEN™ m-LLDPE (available from LyondellBasell), and ELTEX™ PF m-LLDPE (available from Ineos Olefins & Polymers).

“Ethylene plastomers/elastomers” are substantially linear, or linear, ethylene/α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. Ethylene plastomers/elastomers have a density from 0.870 g/cc, or 0.880 g/cc, or 0.890 g/cc to 0.900 g/cc, or 0.902 g/cc, or 0.904 g/cc, or 0.909 g/cc, or 0.910 g/cc, or 0.917 g/cc. Nonlimiting examples of ethylene plastomers/elastomers include AFFINITY™ plastomers and elastomers (available from The Dow Chemical Company), EXACT™ Plastomers (available from ExxonMobil Chemical), Tafmer™ (available from Mitsui), Nexlene™ (available from SK Chemicals Co.), and Lucene™ (available LG Chem Ltd.).

Melt flow rate (MFR) is measured in accordance with ASTM D 1238, Condition 280° C./2.16 kg (g/10 minutes).

Melt index (MI) is measured in accordance with ASTM D 1238, Condition 190° C./2.16 kg (g/10 minutes).

“Melting Point” or “Tm” as used herein (also referred to as a melting peak in reference to the shape of the plotted DSC curve) is typically measured by the DSC (Differential Scanning calorimetry) technique for measuring the melting points or peaks of polyolefins as described in U.S. Pat. No. 5,783,638. It should be noted that many blends comprising two or more polyolefins will have more than one melting point or peak, many individual polyolefins will comprise only one melting point or peak.

Molecular weight distribution (Mw/Mn) is measured using Gel Permeation Chromatography (GPC). In particular, conventional GPC measurements are used to determine the weight-average (Mw) and number-average (Mn) molecular weight of the polymer and to determine the Mw/Mn. The gel permeation chromatographic system consists of either a Polymer Laboratories Model PL-210 or a Polymer Laboratories Model PL-220 instrument. The column and carousel compartments are operated at 140° C. Three Polymer Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards are purchased from Polymer Laboratories (Shropshire, UK). The polystyrene standards are prepared at 0.025 grams in 50 milliliters of solvent for molecular weights equal to or greater than 1,000,000, and 0.05 grams in 50 milliliters of solvent for molecular weights less than 1,000,000. The polystyrene standards are dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let., 6, 621 (1968)):

M_{polypropylene}=0.645(M_{polystyrene}).

Polypropylene equivalent molecular weight calculations are performed using Viscotek TriSEC software Version 3.0.

An “olefin-based polymer,” as used herein, is a polymer that contains more than 50 weight percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains more than 50 weight percent polymerized propylene monomer (based on the total amount of polymerizable monomers) and, optionally, may contain at least one comonomer.

### BRIEF DESCRIPTION OF THE DRAWINGS

FIG. 1 is a perspective view of a packaging article having a sleeve and a product (a laptop computer), to be inserted into the sleeve, in accordance with an embodiment of the present disclosure.

FIG. 2 is a perspective view of the product of FIG. 1 being inserted into the sleeve of the packaging article, in accordance with an embodiment of the present disclosure.

FIG. 3 is a top plan view of the product located in the sleeve of the packaging article, in accordance with an embodiment of the present disclosure.

FIG. 4 is an enlarged fragmentary perspective view of area 4 of FIG. 2, showing the stretching of the three dimensional loop material during insertion of the product into the sleeve.

FIG. 5 is an enlarged fragmentary perspective view of area 5 of FIG. 3 with the product inserted into the sleeve.

FIG. 6 is a perspective view of a packaging article and a product (a bottle), in accordance with an embodiment of the present disclosure.

FIG. 7 is a perspective view of the bottle of FIG. 6 after insertion into a pocket of the packaging article of FIG. 6, in accordance with an embodiment of the present disclosure.

FIG. 8 is a top plan view of the bottle located in the pocket of the packaging article of FIG. 6.

FIG. 9 is a top perspective view of a packaging article and a product (eggs), in accordance with an embodiment of the present disclosure.

FIG. 10 is a top plan view of the eggs located in the pockets of the packaging article of FIG. 9.

FIG. 11 is an exploded perspective view of another packaging article in accordance with an embodiment of the present disclosure.

FIG. 12 is a sectional view taken along line 12-12 of FIG. 11.

### DETAILED DESCRIPTION

The present disclosure provides a packaging article. In an embodiment, the packaging article includes a body having a geometric shape. The body is composed of a three-dimensional random loop material (3DRLM). The 3DRLM is composed of an olefin-based polymer. A sleeve extends through an interior portion of the body. The sleeve has opposing ends on respective opposing surfaces of the body. The sleeve includes an opening at each respective end on the respective opposing surfaces of the body. Each opening has a closed width. The packaging article includes a product. The product has an insert shape, the insert shape has an insert width that is greater than or equal to the closed width of the sleeve opening. A portion of the 3DRLM moves from a neutral state to a stretched state when the product is inserted into the sleeve.

### 1. Body and 3D Loop Structure

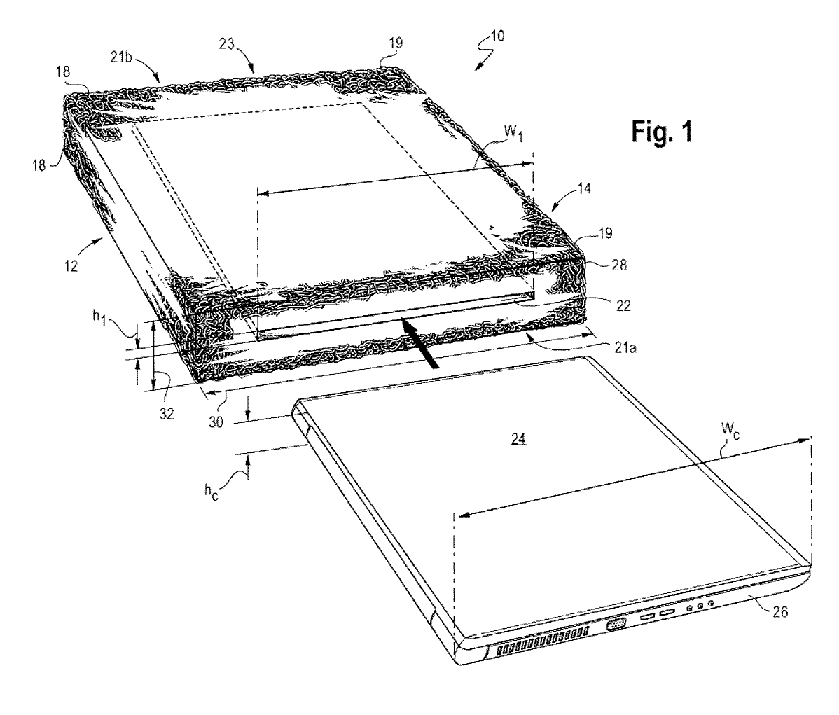

Referring to the drawings, and initially to FIG. 1, a packaging article is shown and indicated generally by the reference numeral 10. The packaging article 10 includes a body 12 having a geometric shape, the body being composed of a three-dimensional random loop material 14. A “geometric shape,” as used herein, is a three dimensional shape or a three dimensional configuration having a length, a width, and a height. The geometric shape can be a regular three dimensional shape, an irregular three dimensional shape, and combinations thereof. Nonlimiting examples of regular three-dimensional shapes include cube, prism, sphere, cone, and cylinder. The body may be solid or hollow. It is understood that when the geometric shape of the body is a prism, the prism can have a cross-sectional shape that is a regular polygon, or an irregular polygon having three, four, five, six, seven, eight, nine, 10 or more sides.

The body is composed of a three dimensional random loop material 14. A “three dimensional random loop material” (or “3DRLM”) is a mass or a structure of a multitude of loops 16 formed by allowing continuous fibers 18, to wind to permit respective loops to come in contact with one another in a molten state and to be heat-bonded at most of the contact points 19. Even when a great stress to cause significant deformation is given, the 3DRLM 18 absorbs the stress with the entire net structure composed of three-dimensional random loops melt-integrated, by deforming itself; and once the stress is lifted, elastic resilience of the polymer manifests itself to allow recovery to the original shape of the structure. When a net structure composed of continuous fibers made from a known non-elastic polymer is used as a cushioning material, plastic deformation is developed and the recovery cannot be achieved, thus resulting in poor heat-resisting durability. When the fibers are not melt-bonded at contact points, the shape cannot be retained and the structure does not integrally change its shape, with the result that a fatigue phenomenon occurs due to the concentration of stress, thus unbeneficially degrading durability and deformation resistance. In certain embodiments, melt-bonding is the state where all contact points are melt-bonded.

A nonlimiting method for producing 3DRLM 14 includes the steps of (a) heating a molten olefin-based polymer, at a temperature 10° C.-140C° C. higher than the melting point of the polymer in a typical melt-extruder; (b) discharging the molten interpolymer to the downward direction from a nozzle with plural orifices to form loops by allowing the fibers to fall naturally. The polymer may be used in combination with a thermoplastic elastomer, thermoplastic non-elastic polymer or a combination thereof. The distance between the nozzle surface and take-off conveyors installed on a cooling unit for solidifying the fibers, melt viscosity of the polymer, diameter of orifice and the amount to be discharged are the elements which decide loop diameter and fineness of the fibers. Loops are formed by holding and allowing the delivered molten fibers to reside between a pair of take-off conveyors (belts, or rollers) set on a cooling unit (the distance therebetween being adjustable), bringing the loops thus formed into contact with one another by adjusting the distance between the orifices to this end such that the loops in contact are heat-bonded as they form a three-dimensional random loop structure. Then, the continuous fibers, wherein contact points have been heat-bonded as the loops form a three-dimensional random loop structure, are continuously taken into a cooling unit for solidification to give a net structure. Thereafter, the structure is cut into a desired length and shape. The method is characterized in that the olefin-based polymer is melted and heated at a temperature 10° C.-140° C. higher than the melting point of the interpolymer and delivered to the downward direction in a molten state from a nozzle having plural orifices. When the polymer is discharged at a temperature less than 10° C. higher than the melting point, the fiber delivered becomes cool and less fluidic to result in insufficient heat-bonding of the contact points of fibers.

Properties, such as, the loop diameter and fineness of the fibers constituting the cushioning net structure provided herein depend on the distance between the nozzle surface and the take-off conveyor installed on a cooling unit for solidifying the interpolymer, melt viscosity of the interpolymer, diameter of orifice and the amount of the interpolymer to be delivered therefrom. For example, a decreased amount of the interpolymer to be delivered and a lower melt viscosity upon delivery result in smaller fineness of the fibers and smaller average loop diameter of the random loop. On the contrary, a shortened distance between the nozzle surface and the take-off conveyor installed on the cooling unit for solidifying the interpolymer results in a slightly greater fineness of the fiber and a greater average loop diameter of the random loop. These conditions in combination afford the desirable fineness of the continuous fibers of from 100 denier to 100000 denier and an average diameter of the random loop of not more than 100 mm, or from 1 millimeter (mm), or 2 mm, or 10 mm to 25 mm, or 50 mm. By adjusting the distance to the aforementioned conveyor, the thickness of the structure can be controlled while the heat-bonded net structure is in a molten state and a structure having a desirable thickness and flat surface formed by the conveyors can be obtained. Too great a conveyor speed results in failure to heat-bond the contact points, since cooling proceeds before the heat-bonding. On the other hand, too slow a speed can cause higher density resulting from excessively long dwelling of the molten material. In some embodiments the distance to the conveyor and the conveyor speed should be selected such that the desired apparent density of 0.005-0.1 g/cc or 0.01-0.05 g/cc can be achieved.

In an embodiment, the 3DRLM 30 has, one, some, or all of the properties (i)-(iii) below:

(i) an apparent density from 0.016 g/cc, or 0.024 g/cc, or 0.032 g/cc to 0.040 g/cc, or 0.048 g/cc; and/or

(ii) a fiber diameter from 0.1 mm, or 0.5 mm, or 0.7 mm, or 1.0 mm, or 1.5 mm to 2.0 mm to 2.5 mm, or 3.0 mm; and/or

(iii) a thickness (machine direction) from 1.0 cm, 2.0 cm, or 3.0, cm, or 4.0 cm, or 5.0 cm, or 10 cm, or 20 cm to 50 cm, or 75 cm, or 100 cm, or more. It is understood that the thickness of the 3DRLM 14 will vary based on the type of product to be packaged.

The 3DRLM 14 is formed into a three dimensional geometric shape to form the body 12. The 3DRLM 14 is an elastic material which can be compressed and stretched and return to its original geometric shape. An “elastic material,” as used herein, is a rubber-like material that can be compressed and/or stretched and which expands/retracts very rapidly to approximately its original shape/length when the force exerting the compression and/or the stretching is released. The three dimensional random loop material 14 has a “neutral state” when no compressive force and no stretch force is imparted upon the 3DRLM 14. The three dimensional random loop material 14 has “a compressed state” when a compressive force is imparted upon the 3DRLM 14. The three dimensional random loop material 14 has “a stretched state” when a stretching force is imparted upon the 3DRLM 14. The body 12 can be compressed (compressed state), be neutral (neutral state), and be stretched (stretched state) in a similar manner.

The three dimensional random loop material 14 is composed of one or more olefin-based polymers. The olefin-based polymer can be one or more ethylene-based polymers, one or more propylene-based polymers, and blends thereof.

In an embodiment, the ethylene-based polymer is an ethylene/α-olefin polymer. Ethylene/α-olefin polymer may be a random ethylene/α-olefin polymer or an ethylene/α-olefin multi-block polymer. The α-olefin is a C₃-C₂₀ α-olefin, or a C₄-C₁₂ α-olefin, or a C₄-C₈ α-olefin. Nonlimiting examples of suitable α-olefin comonomer include propylene, butene, methyl-1-pentene, hexene, octene, decene, dodecene, tetradecene, hexadecene, octadecene, cyclohexyl-1-propene (allyl cyclohexane), vinyl cyclohexane, and combinations thereof.

In an embodiment, the ethylene-based polymer is a homogeneously branched random ethylene/α-olefin copolymer.

“Random copolymer” is a copolymer wherein the at least two different monomers are arranged in a non-uniform order. The term “random copolymer” specifically excludes block copolymers. The term “homogeneous ethylene polymer” as used to describe ethylene polymers is used in the conventional sense in accordance with the original disclosure by Elston in U.S. Pat. No. 3,645,992, the disclosure of which is incorporated herein by reference, to refer to an ethylene polymer in which the comonomer is randomly distributed within a given polymer molecule and wherein substantially all of the polymer molecules have substantially the same ethylene to comonomer molar ratio. As defined herein, both substantially linear ethylene polymers and homogeneously branched linear ethylene are homogeneous ethylene polymers.

The homogeneously branched random ethylene/α-olefin copolymer may be a random homogeneously branched linear ethylene/α-olefin copolymer or a random homogeneously branched substantially linear ethylene/α-olefin copolymer. The term “substantially linear ethylene/α-olefin copolymer” means that the polymer backbone is substituted with from 0.01 long chain branches/1000 carbons to 3 long chain branches/1000 carbons, or from 0.01 long chain branches/1000 carbons to 1 long chain branches/1000 carbons, or from 0.05 long chain branches/1000 carbons to 1 long chain branches/1000 carbons. In contrast, the term “linear ethylene/α-olefin copolymer” means that the polymer backbone has no long chain branching.

The homogeneously branched random ethylene/α-olefin copolymers may have the same ethylene/α-olefin comonomer ratio within all copolymer molecules. The homogeneity of the copolymers may be described by the SCBDI (Short Chain Branch Distribution Index) or CDBI (Composition Distribution Branch Index) and is defined as the weight percent of the polymer molecules having a comonomer content within 50 percent of the median total molar comonomer content. The CDBI of a polymer is readily calculated from data obtained from techniques known in the art, such as, for example, temperature rising elution fractionation (abbreviated herein as “TREF”) as described in U.S. Pat. No. 4,798,081 (Hazlitt et al.), or in U.S. Pat. No. 5,089,321 (Chum et al.) the disclosures of all of which are incorporated herein by reference. The SCBDI or CDBI for the homogeneously branched random ethylene/α-olefin copolymers is preferably greater than about 30 percent, or greater than about 50 percent.

The homogeneously branched random ethylene/α-olefin copolymer may include at least one ethylene comonomer and at least one C₃-C₂₀ α-olefin, or at least one C₄-C₁₂ α-olefin comonomer. For example and not by way of limitation, the C₃-C₂₀ α-olefins may include but are not limited to propylene, isobutylene, 1-butene, 1-hexene, 4-methyl-1-pentene, 1-heptene, 1-octene, 1-nonene, and 1-decene, or, in some embodiments, 1-butene, 1-hexene, 4-methyl-1-pentene and 1-octene.

The homogeneously branched random ethylene/α-olefin copolymer may have one, some, or all of the following properties (i)-(iii) below:

(i) a melt index (1₂) from 1 g/10 min, or 5 g/10 min, or 10 g/10 min, or 20 g/10 min to 30 g/10 min, or 40 g/10 min, or 50 g/10 min, and/or

(ii) a density from 0.075 g/cc, or 0.880 g/cc, or 0.890 g/cc to 0.90 g/cc, or 0.91 g/cc, or 0.920 g/cc, or 0.925 g/cc; and/or

(iii) a molecular weight distribution (Mw/Mn) from 2.0, or 2.5, or 3.0 to 3.5, or 4.0.

In an embodiment, the ethylene-based polymer is a heterogeneously branched random ethylene/α-olefin copolymer.

The heterogeneously branched random ethylene/α-olefin copolymers differ from the homogeneously branched random ethylene/α-olefin copolymers primarily in their branching distribution. For example, heterogeneously branched random ethylene/α-olefin copolymers have a distribution of branching, including a highly branched portion (similar to a very low density polyethylene), a medium branched portion (similar to a medium branched polyethylene) and an essentially linear portion (similar to linear homopolymer polyethylene).

Like the homogeneously branched random ethylene/α-olefin copolymer, the heterogeneously branched random ethylene/α-olefin copolymer may include at least one ethylene comonomer and at least one C₃-C₂₀ α-olefin comonomer, or at least one C₄-C₁₂ α-olefin comonomer. For example and not by way of limitation, the C₃-C₂₀ α-olefins may include but are not limited to, propylene, isobutylene, 1-butene, 1-hexene, 4-methyl-1-pentene, 1-heptene, 1-octene, 1-nonene, and 1-decene, or, in some embodiments, 1-butene, 1-hexene, 4-methyl-1-pentene and 1-octene. In one embodiment, the heterogeneously branched ethylene/α-olefin copolymer may comprise greater than about 50% by wt ethylene comonomer, or greater than about 60% by wt., or greater than about 70% by wt. Similarly, the heterogeneously branched ethylene/α-olefin copolymer may comprise less than about 50% by wt α-olefin monomer, or less than about 40% by wt., or less than about 30% by wt.

The heterogeneously branched random ethylene/α-olefin copolymer may have one, some, or all of the following properties (i)-(iii) below:

(i) a density from 0.900 g/cc, or 0.0910 g/cc, or 0.920 g/cc to 0.930 g/cc, or 0.094 g/cc;

(ii) a melt index (1₂) from 1 g/10 min, or 5 g/10 min, or 10 g/10 min, or 20 g/10 min to 30 g/10 min, or 40 g/10 min, or 50 g/10 min; and/or

(iii) an Mw/Mn from 3.0, or 3.5 to 4.0, or 4.5.

In an embodiment, the 3DRLM 14 is composed of a blend of a homogeneously branched random ethylene/α-olefin copolymer and a heterogeneously branched ethylene/α-olefin copolymer, the blend having one, some, or all of the properties (i)-(v) below:

(i) a Mw/Mn from 2.5, or 3.0 to 3.5, or 4.0, or 4.5;

(ii) a melt index (1₂) from 3.0 g/10 min, or 4.0 g/10 min, or 5.0 g/10 min, or 10 g/10 min to 15 g/10 min, or 20 g/10 min, or 25 g/10 min;

(iii) a density from 0.895 g/cc, or 0.900 g/cc, or 0.910 g/cc, or 0.915 g/cc to 0.920 g/cc, or 0.925 g/cc; and or

(iv) an 1₁₀/1₂ ratio from 5 g/10 min, or 7 g/10 min to 10 g/10 min, or 15 g/10 min; and/or

(v) a percent crystallinity from 25%, or 30%, or 35%, or 40% to 45%, or 50%, or 55%.

According to Crystallization Elution Fractionation (CEF), the ethylene/α-olefin copolymer blend may have a weight fraction in a temperature zone from 90° C. to 115° C. or about 5% to about 15% by wt., or about 6% to about 12%, or about 8% to about 12%, or greater than about 8%, or greater than about 9%. Additionally, as detailed below, the copolymer blend may have a Comonomer Distribution Constant (CDC) of at least about 100, or at least about 110.

The present ethylene/α-olefin copolymer blend may have at least two, or three melting peaks when measured using Differential Scanning calorimetry (DSC) below a temperature of 130° C. In one or more embodiments, the ethylene/α-olefin copolymer blend may include a highest temperature melting peak of at least 115° C., or at least 120° C., or from about 120° C. to about 125° C., or from about from 122 to about 124° C. Without being bound by theory, the heterogeneously branched ethylene/α-olefin copolymer is characterized by two melting peaks, and the homogeneously branched ethylene/α-olefin copolymer is characterized by one melting peak, thus making up the three melting peaks. Further without being bound by theory, it is believed that 3DRLM having an ethylene/α-olefin copolymer blend with a highest DSC melting peak of at least 115° C. can demonstrate effective heat resistance when subjected to high temperature sterilization processes. Specifically, heat and/or steam sterilization of a 3DRLM may degrade the structural integrity of a structure having a DSC highest melting peak below 115° C. (for example, via compression of the structure), whereas 3DRLM having an ethylene/α-olefin copolymer blend with a highest DSC melting peak of at least 115° C. can be heat resistant and retain their structure. Further, the ethylene/α-olefin copolymer blend may have an enthalpy of fusion value ΔH of at least 120 J/g, or at least 125 J/g when measured via DSC.

Additionally, the ethylene/α-olefin copolymer blend may comprise from about 10 to about 90% by weight, or about 30 to about 70% by weight, or about 40 to about 60% by weight of the homogeneously branched ethylene/α-olefin copolymer. Similarly, the ethylene/α-olefin copolymer blend may comprise from about 10 to about 90% by weight, about 30 to about 70% by weight, or about 40 to about 60% by weight of the heterogeneously branched ethylene/α-olefin copolymer. In a specific embodiment, the ethylene/α-olefin copolymer blend may comprise from about 50% to about 60% by weight of the homogeneously branched ethylene/α-olefin copolymer, and 40% to about 50% of the heterogeneously branched ethylene/α-olefin copolymer.

Moreover, the strength of the ethylene/α-olefin copolymer blend may be characterized by one or more of the following metrics. One such metric is elastic recovery. Here, the ethylene/α-olefin copolymer blend has an elastic recovery, Re, in percent at 100 percent strain at 1 cycle of between 50-80%. Additional details regarding elastic recovery are provided in U.S. Pat. No. 7,803,728, which is incorporated by reference herein in its entirety.

The ethylene/α-olefin copolymer blend may also be characterized by its storage modulus. In some embodiments, the ethylene/α-olefin copolymer blend may have a ratio of storage modulus at 25° C., G′ (25° C.) to storage modulus at 100° C., G′ (100° C.) of about 20 to about 60, or from about 20 to about 50, or about 30 to about 50, or about 30 to about 40.

Moreover, the ethylene/α-olefin copolymer blend may also be characterized by a bending stiffness of at least about 1.15 Nmm at 6 s, or at least about 1.20 Nmm at 6 s, or at least about 1.25 Nmm at 6 s, or at least about 1.35 Nmm at 6 s. Without being bound by theory, it is believed that these stiffness values demonstrate how the ethylene/α-olefin copolymer blend will provide cushioning support when incorporated into 3DRLM fibers bonded to form a cushioning net structure.

In an embodiment, the ethylene-based polymer is an ethylene/α-olefin interpolymer composition having one, some, or all of the following properties (i)-(v) below:

(i) a highest DSC temperature melting peak from 90.0° C. to 115.0° C.; and/or

(ii) a zero shear viscosity ratio (ZSVR) from 1.40 to 2.10; and/or

(iii) a density in the range of from 0.860 to 0.925 g/cc; and/or

(iv) a melt index (1₂) from 1 g/10 min to 25 g/10 min; and/or

(v) a molecular weight distribution (Mw/Mn) in the range of from 2.0 to 4.5.

In an embodiment, the ethylene-based polymer contains a functionalized commoner such as an ester. The functionalized comonomer can be an acetate commoner oran acrylate comonomer. Nonlimiting examples of suitable ethylene-based polymer with functionalized comonomer include ethylene vinyl acetate (EVA), ethylene methyl acrylate EMA, ethylene ethyl acrylate (EEA), and any combination thereof.

In an embodiment, the olefin-based polymer is a propylene-based polymer. The propylene-based polymer can be a propylene homopolymer or a propylene/α-olefin polymer.

The α-olefin is a C₂ α-olefin (ethylene) or a C₄-C₁₂ α-olefin, or a C₄-C₈ α-olefin. Nonlimiting examples of suitable α-olefin comonomer include ethylene, butene, methyl-1-pentene, hexene, octene, decene, dodecene, tetradecene, hexadecene, octadecene, cyclohexyl-1-propene (allyl cyclohexane), vinyl cyclohexane, and combinations thereof.

In an embodiment, the propylene interpolymer includes from 82 wt % to 99 wt % units derived from propylene and from 18 wt % to 1 wt % units derived from ethylene, having one, some, or all of the properties (i)-(vi) below:

(i) a density of from 0.840 g/cc, or 0.850 g/cc to 0.900 g/cc; and/or

(ii) a highest DSC melting peak temperature from 50.0° C. to 120.0° C.; and/or

(iii) a melt flow rate from 1 g/10 min, or 2 g/10 min to 50 g/10 min, or 100 g/10 min; and/or

(iv) a Mw/Mn of less than 4; and/or

(v) a percent crystallinity in the range of from 0.5% to 45%; and/or

(vi) a DSC crystallization onset temperature, Tc-Onset, of less than 85° C.

In an embodiment, the olefin-based polymer used in the manufacture of the 3DRLM 14 contains one or more optional additives. Nonlimiting examples of suitable additives include stabilizer, antimicrobial agent, antifungal agent, antioxidant, processing aid, ultraviolet (UV) stabilizer, slip additive, antiblocking agent, color pigment or dyes, antistatic agent, filler, flame retardant, and any combination thereof.

### 2. Sleeve

The body 12 has a sleeve 20. A “sleeve,” as used herein, is an orifice that extends through the interior of the body, the sleeve having a first end on a first surface of the body and an opposing second end on an opposing second surface of the body. The sleeve is a channel formed through the surrounding 3DRLM 14 for receiving, holding, and supporting an object within the body interior. FIGS. 1-3 show the sleeve 20 has a first end 21a with an opening 22. The sleeve 20 has a second end 21b with an opening 23. The openings 22,23 provide ingress and egress into/from the sleeve. Each opening 22, 23 is located on an outer surface, or on an outermost surface, of the body 12.

The opening (and/or the sleeve) can be formed in the body during the fabrication of the 3DRLM. Alternatively, the opening (and/or the sleeve) can be formed post-fabrication by cutting a slit into the body with a blade member or other cutting device. In this way, the opening (sleeve) can be a slit, formed by cutting the 3DRLM 14 with a blade, such as an electric knife, for example.

Each opening 22, 23 has a closed width. A “closed width,” as used herein, is the width of the opening (sleeve) when the three dimensional random loop material is in the neutral state. FIGS. 1-3 show openings 22, 23 each having a closed width, the closed width having a distance of W1.

The packaging article 10 includes a product. A “product,” as used herein, is a tangible object with a mass of at least one gram and having three dimensions—namely, a length, a width, and a height. Nonlimiting examples of suitable products include consumer electronics products, household goods, medical products, comestibles, and any combination thereof.

Nonlimiting examples of suitable consumer electronics products include computer disk drives, computer input and output (I/O) devices, such as a keyboard, a mouse; speakers; video display/monitor; computer; laptop computer; tablet computer; cellphone; smartphone; camera; handheld computing device; television; audio device; computer printer; 3-D printer; wearable technology; drone; virtual reality equipment; video game equipment; media device; accessories such as power cord and power pack; and any combination thereof.

Nonlimiting examples of suitable household goods include cutlery, glassware, glass picture frames, dishware, small appliances (hair dryer, microwave oven, toaster, food processing device, blender), light bulbs, hardware such as screwdrivers and hammers, and decorative items such as candle holders or vases, and any combination thereof.

Nonlimiting examples of suitable medical products include vials, ampules, syringes, intravenous (IV) bags, medical devices used in surgical suites including trocars, forceps, clamps, retractors, endoscopes, staplers, specula, drills, and any combination thereof.

Nonlimiting examples of suitable comestibles include produce such as fruit and vegetables. Nonlimiting examples of suitable fruit and vegetables include apple; apricot; artichoke; asparagus; avocado; banana; beans; beets; bell peppers; blackberries; blueberries; bok choy; boniato; boysenberries; broccoli; Brussel sprouts; cabbage; cantaloupe; carambola; carrots; cauliflower; celery; chayote; cherimoya; cherries; citrus; clementines; collard greens; coconuts; corn; cranberries; cucumber; dates; dragon fruits; durian; eggplant; endive; escarole; feijoa; fennel; figs; garlic; gooseberries; grapefruit; grapes; green beans; green onions; greens (turnip, beet, collard, mustard); guava; horminy; honeydew melon; horned melon; lettuce (iceberg, leaf and romaine); jackfruit; jicama; kale, kiwifruit; kohirabi; kumquat; leeks; lemons; lettuce; lima beans; limes; longan; loquat; lychee; mandarins; malanga; mandarin oranges; mangos; mangosteen; mulberries; mushrooms; mustard greens; napa; nectarines; okra; onion; oranges; papayas; parsnip; passion fruit; peaches; pears; peas; peppers (bell—red, yellow, green, chili); persimmons; pineapple; plantains; plums; pomegranate; potatoes; prickly pear; prunes; pummel; pumpkin; quince; radicchio; radishes; raisins; rambutan; raspberries; red cabbage; rhubarb; romaine lettuce; rutabaga; shallots; snap peas; snow peas; spinach; sprouts; squash (acorn, banana, buttercup, butternut, hubbard, summer); strawberries; starfruit; string beans; stone fruits; sweet potato; tamarind; tomatoes, tangelo; tangerines; tomatilio; tomato; turnip; ugli fruit; water chestnuts; waxed beans; yams; yellow squash; yucca/cassava; zucchini; and any combination thereof.

### 3. Insert Width

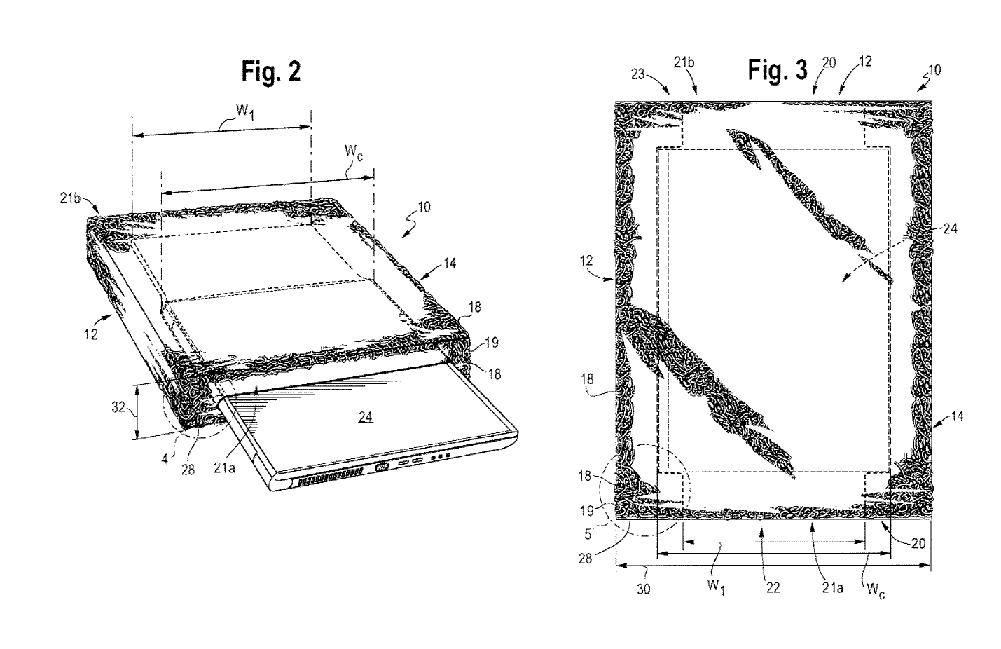

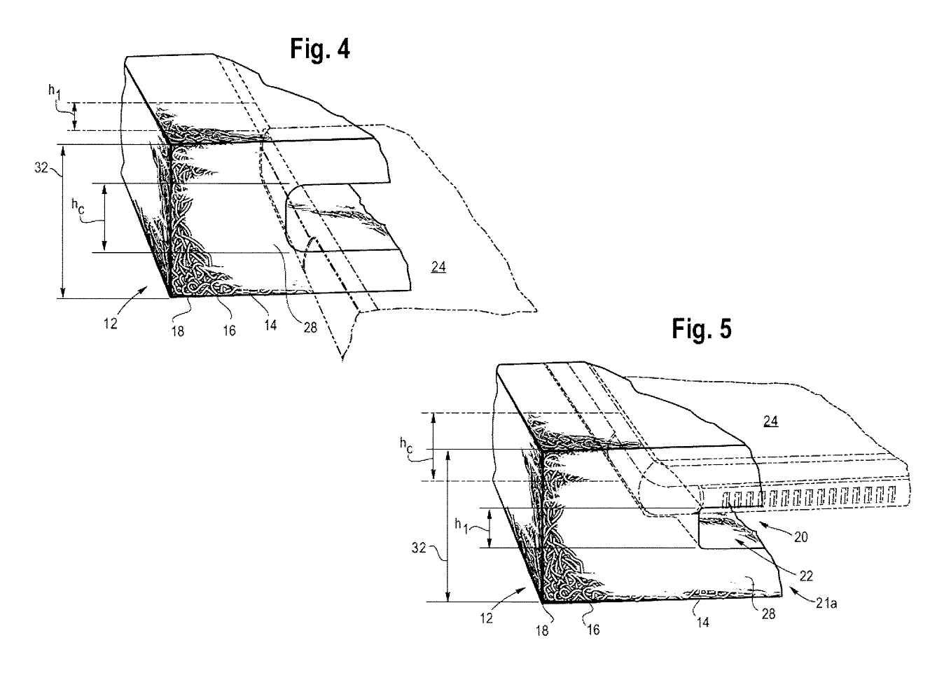

Each opening is located on a surface of the body as disclosed above and hereafter is referred to as “an opening surface.” The product has an insert shape. The “insert shape,” as used herein, is the cross sectional shape of the product, when the product is being inserted into the sleeve 20. The insert shape has a width, hereafter the “insert width,” that is (i) greater than or equal to the closed width of the sleeve 20 and (ii) is less than the width of the opening surface 30, as shown in FIG. 1 and in FIG. 3. A portion of the 3DRLM 14 moves from a neutral state to a stretched state when the product 24 is inserted into the pocket 20 as shown in FIG. 2.

In an embodiment, FIGS. 1-3 show the product as a consumer electronics product, such as a laptop computer 24, for example. The laptop computer 24 has an insert shape 26 that is a rectangle, (cross section of the laptop computer when computer is inserted into opening 22). The insert shape 26 has an insert width W_{c} shown in FIGS. 1-3. The insert width W_{c} of the laptop computer 24 is greater than the closed width W1 of the sleeve 20. As the laptop computer 24 is inserted into the sleeve 20, the laptop computer 24 stretches the 3DRLM 14 and extends the length of the opening 22 from the closed width, W1 to the insert width W_{c}.

The “closed height” is the height of the opening 22 (and/or opening 23) when the 3DRLM 14 is in the neutral state. In an embodiment, the insert shape 26 has a height, hereafter the “insert height,” that is (i) greater than or equal to the closed height, h1, of the sleeve 20 and (ii) is less than height 32 of the opening surface 28 shown in FIG. 1 and FIG. 3. In a further embodiment, the product 24 has an insert height, h_{c}, that is greater than the closed height, h1, of the opening 22 and/or the opening 23.

A portion of the 3DRLM 14 moves from a neutral state to a stretched state when the product 24 is inserted into the sleeve 20 as shown in FIG. 2. FIG. 3 shows the laptop computer 24 fully residing in the sleeve 20. The 3DRLM 14 stretches so the width of the sleeve 20 expands from the closed width W1 to the insert width W_{c}, in order to accommodate the product therein. The insert width W_{c} is greater than the closed width, W1. The 3DRLM 14 in contact with the product 24 stretches around the inserted product, such that the 3DRLM 14 imparts an elastic and compressive contact on and around the laptop computer 24. In this way, the 3DRLM 14 intimately contacts, or otherwise imparts a squeezing force, around opposing sides, or around two sides, or around three sides, or around four sides, or around five sides, or around six sides of the product 24, (i.e., the laptop computer). The squeezing force of the stretched state 3DRLM 14 around the product 24 in the sleeve 20 enables the body to apply a restraining force, or a holding force, upon the product in the sleeve.

The opening may or may not return to the closed width once the product is inserted into the sleeve. In an embodiment, the opening 22 and the opening 23 each return to the closed width W1 once the product 24 is fully inserted into the sleeve 20, as shown in FIG. 3.

In an embodiment, the insert width W_{c} is from 1.0, or 1.01, 1.05, or 1.07, or 1.10, or 1.15, or 1.2, to 1.3, or 1.4, or 1.5 times greater than the closed width, W1 (width measured in centimeters, cm). For example, the product can be a smartphone with a width (i.e., insert width) of 6.4 cm (2.5 inches), a length of 14.0 cm (5.5 inches), and a perimeter of 40.0 cm. The body has an opening with a closed width of 6.0 cm. The body also has a length greater than 14.0 cm in order to accommodate and fully receive the smartphone. When the smartphone is inserted into the closed width, the 3DRLM 14 of the body moves to a stretched state, and the width of the opening increases to the insert width of the smartphone, 6.4 cm. The insert width (6.4 cm) of the smartphone is 1.07 times greater than the closed width (6.0 cm) of the opening.

FIG. 3 shows the opening surface 28 has a width 30. In an embodiment, the insert width W_{c} is from 0.4, or 0.5, or 0.6 to 0.7, or 0.8, or 0.9 times the length of the width 30 of the opening surface 28.

In an embodiment, the body is a prism with a regular polygonal shape. The body has a single, or one and only one, opening on a single (or one and only one) surface.

In an embodiment, the 3DRLM 14 forms a border area around a circumference of the product 24.

In an embodiment, the body 12 provides from 1.0 cm, or 2.0 cm, or 3.0 cm, or 4.0 cm, or 5.0 cm, or 6.0 cm, or 7.0 cm to 8.0 cm, or 9.0 cm, or 10.0 cm, or 11.0 cm, or 12.0 cm, or 13.0 cm, or 14.0 cm of 3DRLM 14 around each surface of the product 24, when the product is fully inserted into the pocket 20. In this way, the body is cushion around the product and protects product 24 from damage due to falls, drops, tips, and/or stacking of the packaging article 10.

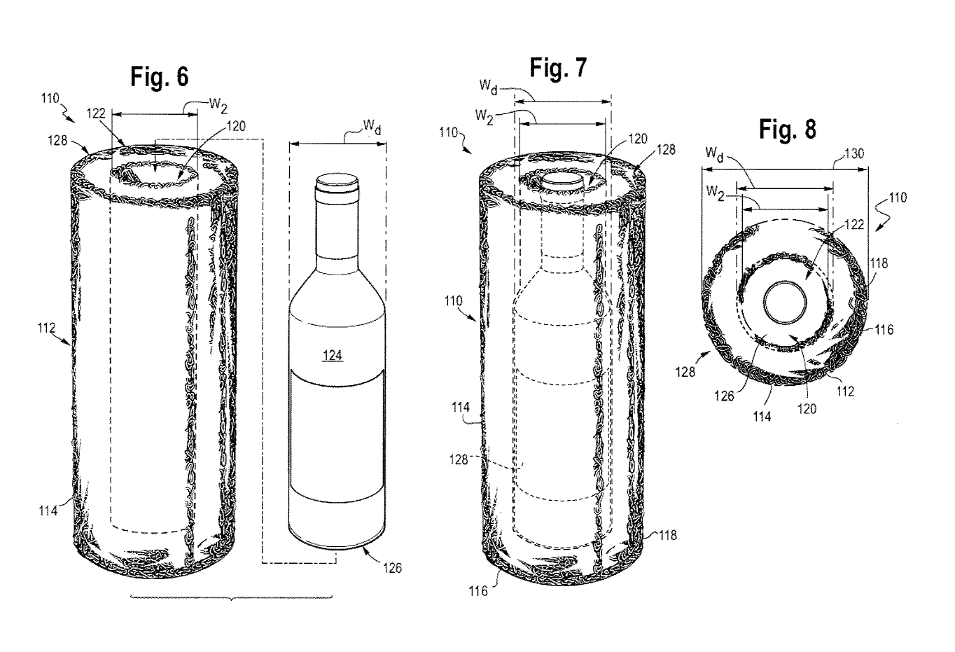

FIGS. 6-8 show an embodiment of the present disclosure wherein a packaging article 110 is provided. The packaging article 110 includes a body 112 having a cylindrical shape, or a substantially cylindrical shape. The body 112 is composed of, or is otherwise formed from, a three-dimensional random loop material 114. The 3DRLM 114 can be any 3DRLM as previously disclosed herein. The 3DRLM 214 has loops 116 and fibers 118. The 3DRLM 114 is formed into a three dimensional shape of the body 112, in this embodiment, a cylinder.

The body 112 has a pocket 120. A “pocket,” as used herein, is an enclosure in the interior of the body, the pocket formed by the surrounding 3DRLM 14 for receiving, holding, and supporting an object within the body interior. The pocket has a single opening (or one and only one opening) for ingress and egress into/from the enclosure. The opening is located on an outer surface, or on an outermost surface, of the body 112.

In an embodiment, the pocket is a sleeve, whereby one of the sleeve ends has an opening and the opposing sleeve end is closed, or otherwise has no opening. The closed sleeve end is composed of 3DRLM and is part of the body.

The pocket 120 has a single opening 122 for ingress and egress into/from the pocket 120. In an embodiment, the opening 122 is located on a top outer surface of the body 112 as shown in FIGS. 6-8. The top outer surface is the opening surface 128.

The opening 122 has a closed width, W₂. The product is a comestible, such as a bottle 124 containing a liquid, such as a liquid beverage, for example. The insert shape 126 of the bottle 124, from cross sectional view, is a circle. The insert width, Wd, of the insert shape 126 is the diameter of the circle, or the width (diameter) of the insert shape (circle). The insert width, Wd, is greater than the closed width, W2, and the insert width, Wd, is less than the width 130 of the opening surface 128.

A portion of the 3DRLM 114 surrounding the bottle 124 moves from a neutral state to a stretched state when the bottle 124 is inserted into the pocket 120. The body maintains its geometric shape of a cylinder when the bottle 124 is completely inserted into the pocket 120.

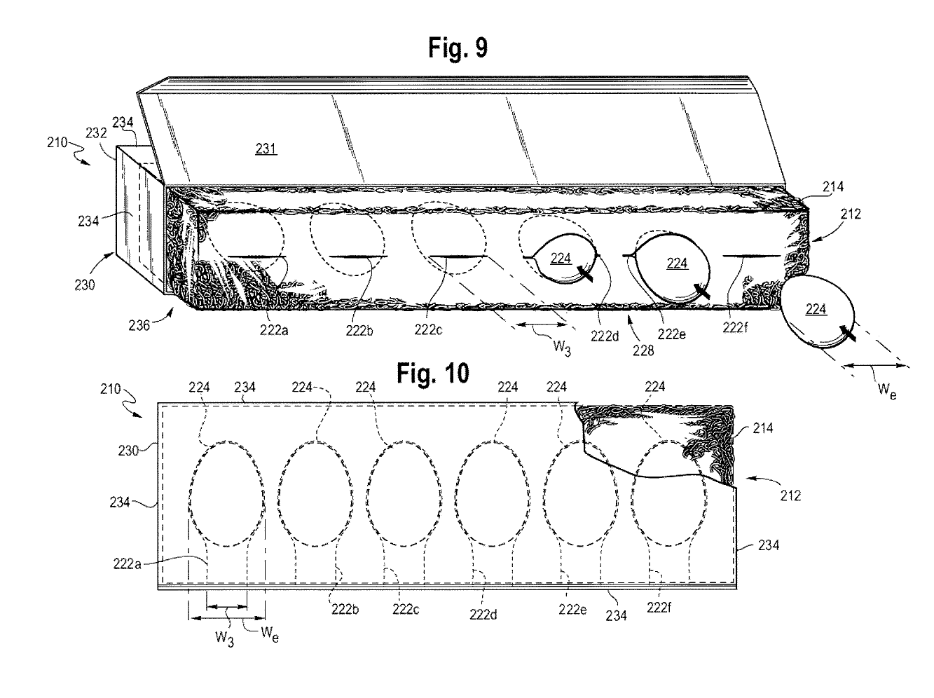

FIGS. 9-10 show an embodiment of the present disclosure wherein a packaging article 210 is provided. The packaging article 210 includes a body 212 having a regular geometric shape that is a rectangular prism. The body 212 is composed of, or is otherwise formed from, a three-dimensional random loop material 214. The 3DRLM 214 can be any 3DRLM as previously disclosed herein. The 3DRLM 214 is formed into a three dimensional shape to form the body 212. The body 212 has a plurality of pockets 220a, 220b, 220c, 220d, 220e, 220f.

Each pocket 220a-220f has a respective opening 222a-222f, that is a slit, for ingress and egress into/from the pockets 220a-220f. The openings 222a-222f are located on the same top outer surface of the body 212. The top surface is the opening surface 228.

Each opening 222a-222f has a respective closed width, W3. The product is a food product, such as an egg 224. The insert shape 226 for each egg, from cross sectional view, is a circle. The insert width, We, for each egg is the diameter of the circle, or the width (diameter) of the insert shape (circle). The insert width, We, is greater than the closed width, W3.

A portion of the 3DRLM 214 surrounding each egg 224 moves from a neutral state to a stretched state when the eggs 224 are inserted into respective pockets 120a-120f. The body 214 maintains its geometric shape of a rectangular prism when the eggs 224 are completely inserted into respective pockets 220a-22f.

When an egg is located in its respective pocket, the elastic nature of the 3DRLM 214 enables the 3DRLM 214 to compressively contact all, or substantially all, the outer surface of each egg, cushioning the entire surface of each egg and providing a holding force, or grip, on each egg. The elasticity of the 3DRLM 214 advantageously holds the eggs in place and reduces the risk of the eggs inadvertently falling from the packaging article 210. The elasticity of the 3DRLM 214 can be tailored to the product (eggs in this embodiment) by adjusting the polymeric composition used to form the 3DRLM. The polymeric composition of the 3DRLM can be selected such that the elasticity of the 3DRLM is sufficient to hold the egg in the pocket with a gentle compressive force that avoids damaging or cracking the egg.

In an embodiment, the body is a rectangular prism with the openings 220a-220f on a single surface (i.e., opening surface 228) of the rectangular prism.

In an embodiment, FIGS. 9-10 show the packaging article includes a container 230. The container 230 includes a top wall 231, a bottom wall 232 and four sidewalls 234. The walls 231-234 form a compartment 236. The top wall 231 and/or the bottom wall 232 may or may not be attached to one or more sidewalls. For example, the top wall 231 may be a discrete stand-alone component, that is placed on the sidewalls, forming a closed compartment (along with the bottom wall). In an embodiment, the top wall 231 is attached by way of a hinge to one of the sidewalls (i.e., a fold between the top wall and the sidewall).

FIGS. 9-10 show body 214 (with the product 224 (eggs)) placed in the compartment 236. The container 230 is an outer container and provides additional protection to the product. Nonlimiting examples of suitable material for the container 230 include paper product (paper, cardboard), polymeric material, wood, metal, and any combination thereof.

In an embodiment, the packaging article 210 passes the drop test and/or the vibration test as measured in accordance with International Safe Transit Association (“ISTA”) 3A. In a further embodiment, the product of the packaging article is a laptop computer and the packaging article passes the drop test and/or the vibration test as measured in accordance ISTA 3A.

ISTA Test procedure 3A is for packaged-products weighing 150 lb. (70 kg) or less, and is a general simulation test for individual packaged-products shipped through a parcel delivery system. The 3A test is appropriate for four different types of packages commonly distributed as individual packages, either by air or ground. The types include standard, small, flat and elongated packages. The 3A test includes an optional test combining Random Vibration under Low Pressure (simulated high altitude). This tests the container's (whether primary package of transport package) ability to hold a seal of closure and the retention of contents (liquid, powder or gas) without leaking.

STANDARD packaged-products are defined as any packaged-product that does not meet any of the definitions below for a small, flat, or elongated packaged-product. A standard packaged-product may be packages such as traditional fiberboard cartons, as well as plastic wooden or cylindrical containers.

SMALL packaged-products are defined as any packaged-product where the: volume is less than 13,000 cm3 (800 in³), longest dimension is 350 mm (14 in) or less, and weight is 4.5 kg (10 lb) or less.

FLAT packaged-products are defined as any packaged-product where the shortest dimension is 200 mm (8 in) or less, next longest dimension is four (4) or more times larger than the shortest dimension, and volume is 13,000 cm³ (800 in³) or greater.

ELONGATED packaged-products are defined as any packaged-product where the longest dimension is 900 mm (36 in) or greater, and both of the packages other dimensions are each 2 percent or less of that of the longest dimension.

### Test Sequence STANDARD

| | | | For ISTA |
|---|---|---|---|
| Sequence # | Test Category | Test Type | Certification |
| 1 | Atmospheric | Temperature | Required |
| | Preconditioning TEST | and Humidity | |
| | BLOCK 1 | | |
| 2 | Atmospheric | Controlled | Optional |
| | Conditioning TEST | Temperature | |
| | BLOCK 1 | and Humidity | |
| 3 | Shock TEST BLOCK 3 | Drop | Required |
| 4 | Vibration TEST BLOCKS | Random | Required |
| | 4 & 7 for Standard TEST | Vibration | |
| | BLOCKS 5 & 7 for Pails | Under Low | |
| | And Short Cylinders | Pressure | |
| 5 | Vibration TEST BLOCKS | Random | Optional |
| | 2 & 8 | Vibration | |
| | | Under Low | |
| | | Pressure | |
| 6 | Shock TEST BLOCK 9 | Drop | Required |

### Test Sequence SMALL

| | | | For ISTA |
|---|---|---|---|
| Sequence # | Test Category | Test Type | Certification |
| 1 | Atmospheric | Temperature | Required |
| | Preconditioning TEST | and Humidity | |
| | BLOCK 1 | | |
| 2 | Atmospheric | Controlled | Optional |
| | Preconditioning TEST | Temperature | |
| | BLOCK 1 | and Humidity | |
| 3 | Shock TEST BLOCK 3 | Drop | Required |
| 4 | Vibration TEST BLOCKS | Random with | Required |
| | 6 & 7 | and without | |
| | | Top Load | |
| 5 | Vibration TEST BLOCKS | Random | Optional |
| | 2 & 8 | Vibration | |
| | | Under Low | |
| | | Pressure | |
| 6 | Shock TEST BLOCK 9 | Drop | Required |

### Test Sequence FLAT

| | | | For ISTA |
|---|---|---|---|
| Sequence # | Test Category | Test Type | Certification |
| 1 | Atmospheric | Temperature | Required |
| | Preconditioning TEST | and Humidity | |
| | BLOCK 1 | | |
| 2 | Atmospheric | Controlled | Optional |
| | Conditioning TEST | Temperature | |
| | BLOCK 1 | and Humidity | |
| 3 | Shock TEST BLOCK 3 | Drop | Required |
| 4 | Vibration TEST BLOCKS | Random with | Required |
| | 4 & 7 | and without | |
| | | Top Load | |
| 5 | Vibration TEST BLOCKS | Random | Optional |
| | 2 & 6 | Vibration | |
| | | Under Low | |
| | | Pressure | |
| 6 | Shock TEST BLOCK 9 | Drop | Required |
| 7 | Shock TEST BLOCK 10 | Rotational | Required |
| | | Edge Drop | |
| 8 | Shock TEST BLOCK 11 | Full Rotational | Required |
| | | Flat Drop | |
| 9 | Shock TEST BLOCK 12 | Concentration | Required |
| | | Impact | |

### Test Sequence ELONGATED

| | | | For ISTA |
|---|---|---|---|
| Sequence # | Test Category | Test Type | Certification |
| 1 | Atmospheric | Temperature | Required |
| | Preconditioning TEST | and Humidity | |
| | BLOCK 1 | | |
| 2 | Atmospheric | Controlled | Optional |
| | Conditioning TEST | Temperature | |
| | BLOCK 1 | and Humidity | |
| 3 | Shock TEST BLOCK 3 | Drop | Required |
| 4 | Vibration TEST BLOCKS | Random with | Required |
| | 4 & 7 | and without | |
| | | Top Load | |
| 5 | Vibration TEST BLOCKS | Random | Optional |
| | 2 & 8 | Vibration | |
| | | Under Low | |
| | | Pressure | |
| 6 | Shock TEST BLOCK 9 | Drop | Required |
| 7 | Shock TEST BLOCK 10 | Rotational | Required |
| | | Edge Drop | |
| 8 | Shock TEST BLOCK 11 | Full Rotational | Required |
| | | Flat Drop | |
| 9 | Shock TEST BLOCK 13 | Bridge Impact | Required |

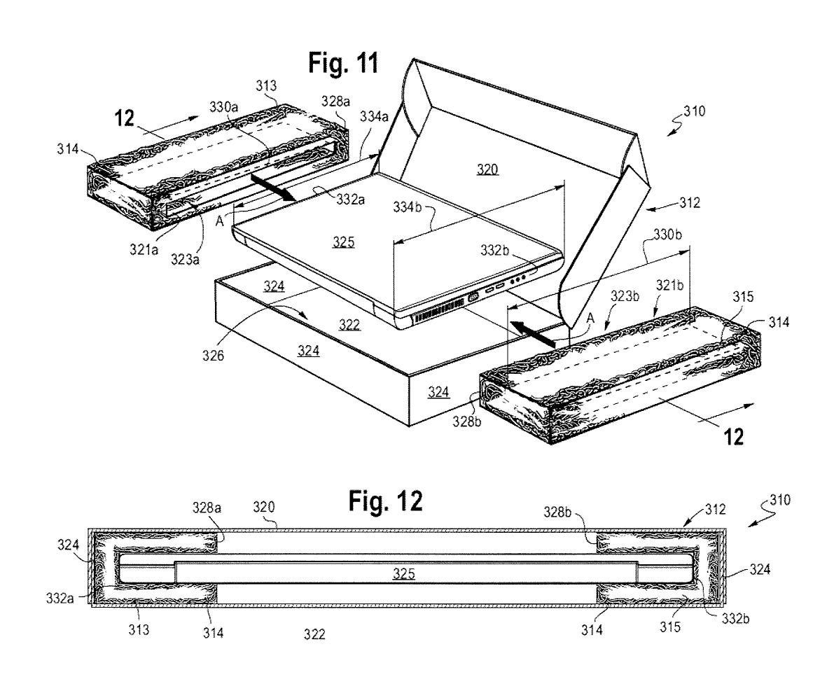

The present disclosure provides another packaging article. FIGS. 11-12 show an embodiment wherein packaging article 310 includes a container 312. The container 312 includes a top wall 320, a bottom wall 322, and sidewalls 324 extending between the top wall and the bottom wall. The walls 320-324 form a compartment 326. The container 312 has four sidewalls 324 shown in FIGS. 11-12.

The top wall 320 and/or the bottom wall 322 may or may not be attached to one or more sidewalls. For example, the top wall 320 may be a discrete stand-alone component, that is placed on the sidewalls, forming a closed compartment (along with the bottom wall). In an embodiment, the top wall 320 is attached by way of a hinge to one of the sidewalls (i.e., a fold between the top wall and the sidewall) as shown in FIG. 11.

The top wall and/or the bottom wall 320, 322 may comprise one, two, or more flaps attached to respective one, two, or more sidewalls.

The container 312 can be openable from the top wall, the bottom wall, or a sidewall. In an embodiment, the container 12 is openable by way of the top wall.

The walls 320-324 are made of a rigid material. Nonlimiting examples of suitable material for the walls include cardboard, polymeric material, metal, wood, fiberglass, and any combination thereof. In an embodiment, container 312 has top/bottom walls and four sidewalls, the walls 320-324 are made of a corrugated cardboard.

In an embodiment, the container 312 is selected from a corrugated cardboard shipping box (such as Federal Express (FedEx) or United Parcel Service (UPS) corrugated cardboard shipping box), or a roll end lock front container or a “RELF” container. The RELF container may or may not include dust flaps.

The container 312 is openable and closable between an open configuration and a closed configuration. An “open configuration” is an arrangement of the walls which allows access to the compartment. A “closed configuration” is an arrangement of the walls preventing, or otherwise denying, access to the compartment. When the container 312 is in the closed configuration, the walls form a completely enclosed compartment. For example, FIG. 11 shows the container 312 in an open configuration with top wall retracted, permitting access to the compartment 326. FIG. 12 shows a cross-sectional view of container 312 in the closed configuration.

The packaging article 310 includes at least two bodies, each body being a geometric shape that is an endcap 313, 315. An “endcap,” as used herein, is a prism of 3DRLM 314 having a pocket and a surface with an opening for the pocket. The endcap is dimensioned to have opposing sides that extend and contact opposing sidewalls of the container when the endcap is placed in the compartment, while maintaining accessibility to the pocket for insertion of the product.

Each endcap 313,315 is composed of a three-dimensional random loop material (3DRLM) 314 composed of an olefin-based polymer as disclosed above. Each endcap 313, 315 has a respective pocket 321a, 321b in an interior portion of the body. Each pocket 321a, 321b has a respective opening 323a, 323b. Each opening 323a, 323b is located on a respective opening surface 328a, 328b. Each opening 323a, 323b has a closed width 330a, 330b. A product 325 (such as a laptop computer in FIGS. 11-12, for example) has opposing ends 332a, 332b. In an embodiment, endcap 313 has the same, or substantially the same, size and shape of endcap 315. Each endcap 313, 315 is made of the 3DRLM as disclosed above.

Each product end 332a, 332b has an insert shape. In FIGS. 11-12, the insert shape of for each product end 332a, 332b of the laptop computer is a rectangle. The insert width 334a, 334b for respective product ends 332a, 332b (rectangle) of the laptop computer is greater than the respective pocket closed widths 330a, 330b.

Endcaps 313, 315 are placed around the product 325 by inserting the product ends 332a, 332b of the laptop computer (product 325) into respective pocket openings 323a, 323b. For each endcap 313, 315, a portion of (or all of) the 3DRLM 314 moves from a neutral state to a stretched state when the product ends 332a, 332b are inserted into respective pocket openings 323a, 323b.

The endcap-product-endcap assembly is subsequently placed into the compartment 326. In the compartment 326, endcap 313 contacts the front sidewall and extends to, and contacts, the opposing sidewall, namely the rear sidewall. Similarly, endcap 315 contacts the front sidewall and extends to, and contacts, the opposing rear sidewall. In the compartment 326, the endcaps 313, 315 are spaced apart from each other and are in parallel relation to each other (or in substantially parallel relation to each other). In other words, the endcaps 313, 315 are parallel to, and spaced apart from, each other in the compartment 326.

FIGS. 11-12 show the endcaps 313, 315 oppose each other when in the compartment 326 so that opening 323a of the endcap 313 opposes, or otherwise faces, the opening 323b of endcap 315.

In an embodiment, the endcap-product-endcap assembly has a height that is greater than the depth of the compartment 326. When the container 312 is in the closed configuration, the walls (top/bottom walls 320,322 in particular) compress the 3DRLM 314 of each endcap. The endcaps 313, 315 support the product 325, such that the product 325 (laptop computer) does not contact any wall of the container 312. FIG. 12 shows the product 325 (laptop computer) extending from endcap 313 to endcap 315, the product 325 (laptop computer) suspended below the top wall 320, and product 325 also suspended above the bottom wall 322. The 3DRLM 314 at the closed end of each endcap 313, 315 prevents the product ends 332a, 332b from contacting any of the walls. When the container 312 is in the closed configuration, the 3DRLM 314 of each endcap 313, 315 simultaneously experiences both (i) a stretched state (vis-à-vis product end insertion into the pocket) and a compressed state (compressive force imparted onto the 3DRLM by the walls).

In an embodiment, the packaging article 310 passes the drop test and/or the vibration test as measured in accordance with ISTA 3A. In a further embodiment, the product of the packaging article is a laptop computer and the packaging article passes the drop test and/or the vibration test as measured in accordance with ISTA 3A.

The present packaging article 10, 110, 210, 310 each advantageously provides one, some, or all of the following features (1)-(5) provided below:

(1) Energy management—the body (bodies) composed of 3DRLM provides resistance and protects the product from impact, shock, vibration, or compression resistance typically experienced by a packaging article during handling and shipping via truck, rail, air, etc. The present packaging article provides ease-of-use to package while simultaneously providing higher drop/impact and/or vibration resistance, yielding a conformed energy management packaging system.

(2) Conformability—as the product is introduced into the opening, the body of 3DRLM stretches and conforms around the product.

(3) Breathable and Hygenic—the body composed of 3DRLM provides the packaging article with enhanced breathability, which is advantageous for products such as fresh produce which may contain excess moisture. Because of 3DRLM's open loop structure, the body does not retain water and therefore the packaging article reduces, or eliminates the risk of bacterial/fungal/mold growth within the packaging article. Low or no risk of contamination vis-à-vis the packaging is particularly beneficial when the product is a comestible such as fresh produce, for example.

(4) Washable—the body is readily washable and quickly drains and dries after washing or wetting. In addition, moisture or wetness does not detract from the 3DRM's ability to cushion and protect the product. The body composed of 3DRLM operates in wet or dry conditions without loss of performance.

(5) Reusable—The body composed of 3DRLM is reusable and/or recyclable which is advantageous over packaging material composed of polyurethane foam, crosslinked foams, and/or polystyrene foams, for example.

By way of example, and not limitation, examples of the present disclosure are provided.

### EXAMPLES

### Example 1

Ends (product ends) of a laptop computer (laptop) are inserted into pockets of two respective endcaps composed of 3DRLM, as shown in FIGS. 11-12. 3DRLM has an apparent density of 0.3 g/cc and is formed from a linear low density polyethylene (LLDPE). The laptop ends stretch each pocket closed width to the insert width of each respective laptop end. The endcap-laptop-endcap assembly is placed in a FedEx Large Box having inside dimensions 17.88″×12.38″×3″ (45.40 cm×31.43 cm×7.62 cm). The endcap-laptop-endcap assembly has a height that is greater than the height of the FedEx Large Box, i.e., a height greater than 7.62 cm. The FedEx Large Box is sealed closed, compressing the 3DRLM of each endcap and forming the packaging article. The sealed FedEx Large Box is subsequently subjected to the drop test protocol and the vibration test protocol in accordance with ISTA 3A. After the ISTA 3A testing the FedEx Large Box is opened the laptop computer is removed and the endcaps removed from the laptop. Manual inspection finds no visual damage to the laptop. The laptop is powered on and tested for operational damage and defects. The laptop performs all normal and expected and functions as does the same type of laptop that is not subjected to the ISTA 3A testing protocol. With these results and delivery of a fully operational laptop, the packaging article is certified as passing (i) the ISTA 3A drop test and (ii) the ISTA 3A vibration test.

It is specifically intended that the present disclosure not be limited to the embodiments and illustrations contained herein, but include modified forms of those embodiments including portions of the embodiments and combinations of elements of different embodiments as come with the scope of the following claims

1. A process for producing a packaging article comprising:
providing a body having a geometric shape and composed of a three-dimensional random loop material (3DRLM), the 3DRLM composed of an olefin-based polymer, the body having a sleeve with opposing ends on respective opposing surfaces of the body, the sleeve extending through an interior portion of the body and having an opening at each respective end, each opening having a closed width;
providing a product having an insert shape, the insert shape having an insert width that is greater than or equal to the closed width of the sleeve opening; and
inserting the product into the sleeve.

2. The process of claim 1 comprising inserting the insert shape of the product into a closed width of the sleeve.

3. The process of claim 2 comprising stretching, with the inserting, a portion of the 3DRLM from a neutral state to a stretched state.

4. The process of claim 3 comprising compressively engaging, with the stretching, at least two opposing surfaces of the product.

5. The process of claim 3 wherein the body has an original geometric shape, the process comprising maintaining the original geometric shape of the body when the product is located in the sleeve.

6. The process of claim 3 comprising stretching, with the inserting, the length of the closed width to the length of the insert width.

7. The process of claim 1 comprising forming, with the body, a border area of 3DRLM around a circumference of the product.

8. The process of claim 1 comprising providing from 1.0 cm to 14.0 cm of 3DRLM around each side of the product.

9. The process of claim 1 comprising
providing a body wherein one end of the sleeve is closed; and
forming, with the closed end of the sleeve, a pocket in the body.

10. The process of claim 9 comprising forming, with the pocket, a single opening on a single surface of the body.

11. The process of claim 10 wherein the single opening of the pocket has a closed width, the process comprising stretching, with the inserting, the length of the pocket closed width to the length of the insert width.

12. The process of claim 1 comprising forming the 3DRLM from a material selected from the group consisting of an ethylene-based polymer, a propylene-based polymer, and combinations thereof.

13. The process of claim 1 comprising providing a container having (i) a top wall and a bottom wall, (ii) a plurality of sidewalls extending between the top wall and the bottom wall, the wall defining a compartment;
placing the body in the compartment;
placing the container in a closed configuration; and
passing the drop test or the vibration test as measured in accordance with ISTA 3A.

14. A process for producing a packaging article comprising:
providing a container having (i) a top wall and a bottom wall, (ii) a plurality of sidewalls extending between the top wall and bottom wall, the walls defining a compartment;
providing at least two bodies, each body having a geometric shape of an endcap, each endcap composed of a three-dimensional random loop material (3DRLM) composed of an olefin-based polymer, each endcap having a pocket in an interior portion of the body, each pocket having an opening, each opening having a closed width;
providing a product having opposing ends, each product end having an insert shape, the insert shape having an insert width that is greater than or equal to the closed width of the opening;
inserting each product end into a pocket of a respective endcap and forming an endcap-product-endcap assembly;
moving, with the inserting, a portion of the 3DRLM of at least one endcap from a neutral state to a stretched state; and
placing the endcap-product-endcap assembly into the container.

15. The process of claim 14 comprising
placing the container in a closed configuration; and
passing the drop test or the vibration test as measured in accordance with ISTA 3A.
